(19) United States
(12) Patent Application Publication
(10) Pub. No.: US 2012/0224972 A1
(43) Pub. Date: Sep. 6, 2012

(54) METHOD AND DEVICE FOR PRODUCING AN INTEGRALLY BLADED ROTOR AND ROTOR PRODUCED BY MEANS OF THE METHOD

(75) Inventors: Frank Stiehler, Bad Liebenwerda (DE); Hans Peter Borufka, Starnberg (DE); Patrick Prokopczuk, Munchen (DE)

(73) Assignee: MTU AERO ENGINES GMBH, Munchen (DE)

(21) Appl. No.: 13/508,834

(22) PCT Filed: Nov. 12, 2010
(86) PCT No.: PCT/DE10/01333

§ 371 Date: May 9, 2012

(30) Foreign Application Priority Data
Nov. 13, 2009 (DE) 10 2009 052 882.2

(51) Int. Cl. F01D 5/14; B23P 19/04; B23K 20/12; B23P 15/00

(52) U.S. Cl. 416/223 A; 29/889.21; 29/23.51; 228/112.1; 228/2.1

(57) ABSTRACT

A method for producing an integrally bladed rotor, in particular a gas turbine rotor, by means of joining, comprises the following steps:—Providing a blade (10) having a joining surface;—Providing a retaining mechanism having two clamping jaws (28);—Retaining the blade (10) at two opposite points of blade (10) by means of clamping jaws (28) in a purely force-closed manner; and—Pressing the blade (10) retained in a force-closed manner onto a basic rotor body, so that blade (10) is aligned independently in a joining position. A device for producing an integrally bladed rotor comprises a retaining mechanism for a blade (10) having two clamping jaws (28), and by pressing these jaws together, blade (10) is retained at two opposite points in a purely force-closed manner; and a mechanism for pressing blade (10) retained in a force-closed manner onto a basic rotor body, in such a way that blade (10) is aligned independently in a joining position.

The invention relates to a method and a device for producing an integrally bladed rotor, in particular a gas turbine rotor. The invention further relates to a rotor produced by means of the method.

Gas turbine rotors having integral blading are named blisk or bling depending on whether the rotor or rotor support (called a basic rotor body in the following) that is present is shaped like a disk or a ring in cross section. Blisk is the abbreviated form of “bladed disk” and bling of “bladed ring”.

It is known from the prior art to produce gas turbine rotors having integral blading by milling from solids. Since this method is very complicated and expensive, it is utilized only for producing relatively small gas turbine rotors.

For larger rotors, joining methods are used in which basic rotor body and blades are produced separately and subsequently are joined together. Of the joining methods, linear friction welding (LFW) has gained great importance in the last few years. Here, one of the parts to be joined is firmly clamped in place, while the other oscillates with a linear motion. By pressing the parts together, frictional heat arises. The material in the region of the welding zone is heated to forging temperature. At the same time, the parts are upset, so that a weld bead is formed in the joining region, after which the bead is removed by adaptive milling.

In order to avoid difficulties in the alignment of the blades relative to the basic rotor body for friction welding, in which one of the two parts to be joined must be moved relative to the other, it is known to rigidly weld to both units a prefabricated intermediate piece as a bridge or adapter, so to speak, between basic rotor body and blade. A relative movement between basic rotor body and blade is then no longer necessary, since both parts can be positioned rigidly relative to one another beforehand.

Another joining method is inductive high-frequency pressure welding (IHFP). Such a method for joining blade parts of a gas turbine is known from DE 198 58 702 B4.

The blade parts have joining surfaces, which are essentially positioned flush at a distance from one another. Subsequently, the blade parts are welded together by exciting an inductor with high-frequency current and by bringing the parts together with contact of the joining surfaces. The inductor is excited with a constant frequency that in general lies above 0.75 MHz and is selected as a function of the geometry of the joining surfaces. In the case of inductive high-frequency pressure welding, the sufficiently high and homogeneous heating of the two welding partners is of decisive importance for the quality of the joining site. As a rule, however, only components with relatively small cross sections (order of magnitude <200 mm²) can be reliably welded together, since with larger component cross sections, a sufficient heating of the central or middle cross-sectional regions is not achieved and thus there is no homogeneous heating of the joining sites.

A method for producing an integrally bladed rotor by means of friction welding, in which a blade is firmly held by a tool device by form-fitting with two clamping jaws, is known from EP 1 213 088 B1. In this case, the wedge-shaped clamping jaws penetrate notches on the front edge and back-edge sections of the blade. The form-fitting clamping in place of the blade in the complex tool device is very complicated and can only be carried out manually.

EP 0 513 669 A2 relates to a method for blading a rotationally symmetrical blade support for turbo machines by means of friction welding, in which an uptake mechanism with two clamping jaws that can be clamped against one another are used for fixing a blade in place. By tightening screws, the clamping surfaces of the clamping jaws clamp between them the blade foot on rectangular side surfaces.

The object of the invention is to make possible an exact and reliable positioning of a blade to be joined to the basic rotor body, for producing an integrally bladed rotor by means of joining.

The method according to the invention for producing an integrally bladed rotor, in particular a gas turbine rotor, by means of joining comprises the following steps:
Providing a blade having a joining surface;
Providing a retaining mechanism having two clamping jaws;
Retaining the blade at two opposite points of the blade by means of the clamping jaws in a purely force-closed manner; and
Pressing the blade retained in a force-closed manner onto a basic rotor body, so that the blade is aligned independently in a joining position.

The invention proceeds from the knowledge that coated blades are used in practically all turbines currently produced. Since the protective layer, because of the material, must be applied prior to the joining, only a region that need not be coated is considered for clamping the blade in place in an uptake device. This is usually a region at the blade foot or stated more precisely, the region under the inner shroud, as long as the latter is present.

A prefabricated intermediate piece that is inserted between blade and basic rotation body in the case of several known production methods can be dispensed with, whereby manufacturing costs are decreased for an integrally bladed rotor. In addition, the direct joining of the blade to the basic rotation body implies a reduction in weight and a minimizing of leakage.

In contrast to the technique known from EP 1 213 088 B1, the fixation necessary for the welding process is not achieved by means of a decisive form-fitting achieved with a plurality of components, but rather by continuous introduction of force (force closure), so that complicated mechanics for the fixation can be omitted. With the use of the method according to the invention, two retaining points are sufficient for the fixation.

Another special feature of the invention can be seen in the fact that only a relatively moderate retaining force needs to be introduced (preferably by a hydraulics system). The blade is aligned only by setting the blade in place (pressing on the basic rotor body). Thus, the kinematics of friction welding are utilized in an advantageous way for aligning the blade. An additional positive effect resulting therefrom is the damping of vibrations on the tip of the blade.

Based on the above-described special features, the method according to the invention can be conducted in an automated manner, which is not possible particularly in the case of the known method according to EP 1 213 088 B1. Since only a relatively small force will be introduced for retaining the blade, e.g., a reasonably dimensioned hydraulic device (robot) that grips the blade, transports it and positions it over the basic rotor body can be provided within the framework of automating the method.

The blade is preferably provided with at least one functional section, whereby either the functional section or the retaining mechanism has a hollow profile with an opening accessible from the outside and a front surface and the retaining mechanism or the functional section has at least one retaining section that penetrates the hollow profile for the force-closed retaining of the blade and is pressed in a direction perpendicular to the front surface. The hollow profile and the retaining section matched to it provide for the blade to be retained in a defined manner in all spatial directions, so that a very high positional accuracy of the blade is achieved. The joining process can be conducted with very high forces, as they are necessary for the mechanically-supported direct joining of a blade to a basic rotor body, in particular when the latter have different material properties. The actual joining can be produced by linear friction welding or inductive high-frequency pressure welding.

The device according to the invention for producing an integrally bladed rotor comprises a retaining mechanism for a blade having two clamping jaws and by clamping these together, the blade is retained at two opposite points in a purely force-closed manner; and a mechanism for pressing the blade retained in a force-closed manner onto a basic rotor body, so that the blade is aligned independently in a joining position.

According to a first preferred embodiment, the retaining mechanism has a retaining section with an oblique bearing surface, which is matched to a ramp formed in a hollow profile of a functional section of the blade.

According to a second preferred embodiment, the retaining mechanism has a hollow profile, in which a ramp is formed, the ramp being coordinated with an oblique bearing surface of a retaining section provided on a functional section of the blade.

Finally, the invention also indicates an integrally bladed rotor, in particular for gas turbines, which is produced according to the method according to the invention.

Advantageous and appropriate configurations of the invention are given in the subclaims.

Additional features and advantages of the invention result from the following description and from the appended drawings, to which reference is made. In the drawings:

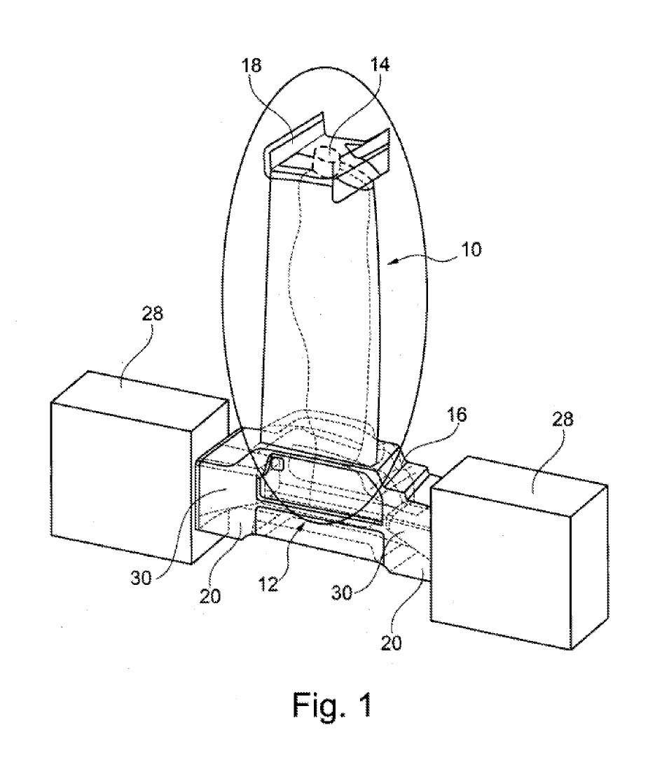

FIG. 1 shows a perspective, partially transparent view of a device according to the invention, with blade clamped in place, with which integrally bladed rotors are produced according to the method according to the invention;

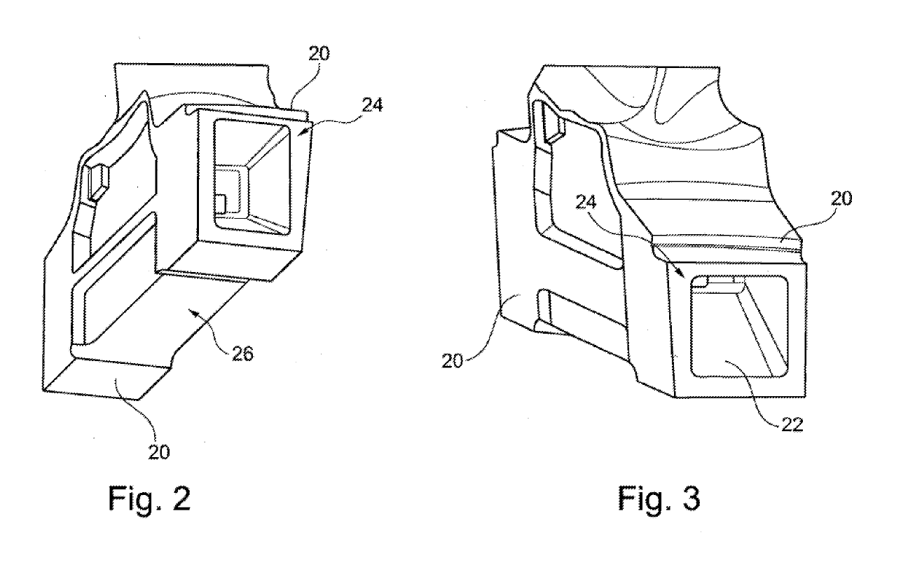

FIGS. 2 and 3 show perspective views of details of the lower region of the blade; and

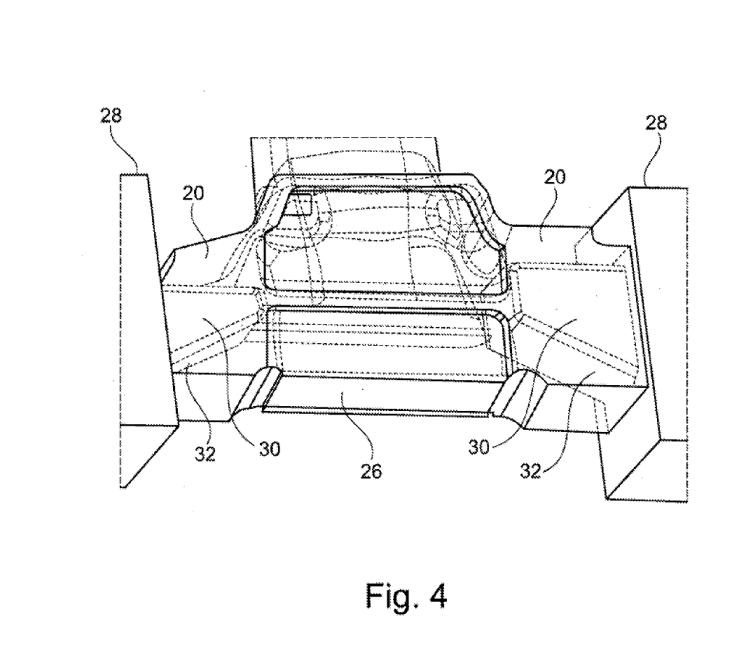

FIG. 4 shows a perspective view of a detail of the uptake device with blade clamped in place.

A part of a device for producing an integrally bladed rotor by means of joining is shown in FIG. 1. The device can be used in particular in the scope of an LFW or IHFP method, which will be discussed later.

The integrally bladed rotor that can be used in the compressor or turbine region of a gas turbine has a basic body in the form of a disk or a ring. Turbine blades 10 are fastened to the basic rotor body that can be formed of polycrystalline material; the blades are formed of monocrystalline material and can be one-piece components of a closed ring of blades.

A blade 10 extends from a blade foot 12, on which blade 10 is fastened to the basic rotor body, up to a tip 14 of the blade surface. An inner shroud 16 and an outer shroud 18 are disposed on blade foot 12 and on blade surface tip 14. The region below the inner shroud 16 is not coated. Two functional sections 20 created as a sprue are provided in this region and are disposed on opposite sides of blade foot 12.

It is recognizable in FIGS. 2 and 3 that functional sections 20 are formed as hollow profiles (open pockets), and thus are essentially hollow on the inside. For both functional sections 20, one of the inner boundary surfaces (the lower one in each of the figures) is designed as a ramp 22. The outer front surface 24, which surrounds the opening of functional section 20, serves as a pressing surface in the joining process.

Also to be seen in FIG. 2 is the joining surface 26 that is opposite of tip 14 of the blade surface and that comes into contact with a corresponding joining surface of the basic rotor body during the joining process.

The device shown in FIGS. 1 and 4 comprises a retaining mechanism, by which blade 10 is retained and positioned relative to the basic rotor body. From the retaining mechanism of the device are shown two clamping jaws that can be moved relative to one another. Each clamping jaw 28 has a protruding retaining section 30, which lies opposite retaining section 30 of the other clamping jaw 28.

Retaining sections 30 are wedge-shaped and taper in the direction toward the opposite-lying clamping jaw 28. The outer shape of retaining section 30 is essentially complementary in each case to the inner profile of one of the pocket-type functional sections 20 of blade 10. In particular, each retaining section 30 has an oblique bearing surface 32, which is inclined corresponding to ramp 22 of the functional section 20 of the blade assigned to it.

In order to fasten blade 10 to the basic rotor body, as is shown in FIGS. 1 and 4, blade 10 is clamped in place in the retaining mechanism by moving clamping jaws 28 toward one another in a direction perpendicular to front surfaces 24. In this way, the wedge-shaped retaining sections 30 of clamping jaws 28 engage in the hollow profiles on blade foot 12, and front surfaces 24 are pressed against clamping jaws 28. In this way, blade 10 is retained in a purely force-closed manner (without form-fitting) at two places. It is correspondingly not necessary to introduce a particularly high clamping force. In fact, a certain play of blade 10 should and shall be present.

The oscillation of blade foot 12 that is necessary for joining by means of linear friction welding to a firmly retained basic rotor body is transferred from clamping jaws 28, which are excited to oscillate, over the front surfaces 24 of blade functional sections 20 pressed thereto onto blade foot 12.

An upsetting force that presses blade 10 in a direction perpendicular to joining surface 26 onto the opposite-lying joining surface of the basic rotor body is necessary both for linear friction welding as well as for the alternative inductive high-frequency pressure welding. After pressing clamping jaws 28 together, this upsetting force is introduced onto blade 10. An essential part of the upsetting force is transferred over oblique bearing surfaces 32 of wedge-shaped retaining sections 30 onto ramps 22 in the pocket-like functional sections 20, whereby blade 10 is pressed in the direction of the basic rotor body. Blade 10 is independently aligned in the desired joining position only by lowering the blade onto the basic rotor body. The desired joining position is already established in the clamping direction. Clamping direction is to be understood essentially as the straight line between the clamping jaws.

Foot 12 of blade 10 clamped in place is free of torque during the welding, while the region of blade 10 encircled in FIG. 1, thus, in particular, the blade surface and the outer shroud 18 is load-free for the most part in this state (as long as the outer shroud 18 is free).

Of course, it is also possible that the hollow profile is not formed on blade functional section 20, but on the retaining mechanism. Correspondingly then, retaining section 30 is not to be provided on the retaining mechanism, but rather on functional section 20. Functional section 20 or retaining section 30 may also be an integral component of blade 10. In this case, a sprue is not necessary.

A defined clamping sequence is achieved with the above-described method and the device belonging thereto. By homogenizing the clamping states, an optimal introduction of very high process forces is assured. The retaining mechanism of the device can be determined mechanically due to the defined contact situations with utilization of very high process forces.

1. A method for producing an integrally bladed rotor, in particular a gas turbine rotor, by means of joining, comprising steps of:
providing a blade (10) having a joining surface;
providing a retaining mechanism having two clamping jaws (28);
retaining the blade (10) at two opposite points of blade (10) by means of clamping jaws (28) in a purely force-closed manner; and
pressing the blade (10) retained in a force-closed manner onto a basic rotor body, so that blade (10) is aligned independently in a joining position.

2. The method according to claim 1, wherein the blade (10) is retained by clamping jaws (28) with play.

3. The method according to claim 1, wherein the blade (10) is provided with at least one functional section (20), whereby either functional section (20) or the retaining mechanism has a hollow profile with an opening accessible from the outside and a front surface (24) and the retaining mechanism or functional section (20) has at least one retaining section that penetrates into the hollow profile and is pressed in a direction perpendicular to front surface (24), for the force-closed retaining of blade (10).

4. The method according to claim 3, wherein when blade (10) is pressed onto the basic rotor body, an essential part of the force used for this is transferred via an oblique bearing surface (32) of retaining section (30) onto a ramp (22) formed in the hollow profile.

5. The method according to claim 4, wherein retaining section (30) of one clamping jaw (28) of the retaining mechanism or of functional section (20) protrudes and, after clamping blade (10), applies front surface (24) to clamping jaw (28) or to functional section (20).

6. The method according to claim 5, wherein oscillations of clamping jaws (28) are introduced over front surface (24) into foot (12) of blade (10).

7. A device for producing an integrally bladed rotor, comprising a retaining mechanism for a blade (10) having two clamping jaws (28), and by pressing these jaws together, blade (10) is retained at two opposite points in a purely force-closed manner; and a mechanism for pressing blade (10) retained in a force-closed manner onto a basic rotor body, in such a way that blade (10) is aligned independently in a joining position.

8. The device according to claim 7, wherein the retaining mechanism has a retaining section (30) with an oblique bearing surface (32), which is matched to a ramp (22) formed in a hollow profile of a functional section (20) of blade (10).

9. The device according to claim 7, wherein the retaining mechanism has a hollow profile, in which a ramp (22) is formed, ramp (22) being matched to an oblique bearing surface (32) of a retaining section (30) provided on a functional section (20) of blade (10).

10. The device according to claim 8, wherein retaining section (30) is wedge-shaped and protrudes from one clamping jaw (28) of the retaining mechanism or from functional section (20) of blade (10), clamping jaw (28) or functional section (20) being engaged on front surface (24) of the hollow profile when blade (10) is in the clamped-in place state.

11. The device according to claim 7, wherein both clamping jaws (28) of the retaining mechanism can be moved toward one another and have retaining sections (30) and/or hollow profiles lying opposite one another, which, when blade (10) is clamped in place, interact with two hollow profiles or retaining sections (30) disposed on opposite sides of blade (10).

12. The device according to claim 7, wherein a mechanism is provided, with which retaining sections (30) or hollow profiles can be excited to oscillate.

13. An integrally bladed rotor, in particular a gas turbine rotor, comprising:
a blade (10) having a joining surface;
a retaining mechanism having two clamping jaws (28);
the blade (10) being retained at two opposite points of blade (10) by the clamping jaws (28) in a purely force-closed manner; the blade (10) being press retained in a force-closed manner onto a basic rotor body, so that blade (10) is aligned independently in a joining position.
